(19) United States
(12) Patent Application Publication
(10) Pub. No.: US 2010/0312694 A1
(43) Pub. Date: Dec. 9, 2010

(54) Mobile Electronic Transaction System, Device and Method Therefor

(76) Inventor: Thomas Homeier-Beals, Royal Oak, MI (US)

Correspondence Address: THE WEINTRAUB GROUP, P.L.C., 28580 Orchard Lake Road, Suite 140, Farmington Hills, MI, 48334, US

(21) Appl. No.: 12/795,313

(22) Filed: Jun. 7, 2010

Related U.S. Application Data
(63) Continuation-in-part of application No. 11/188,169, filed on Jul. 22, 2005, now abandoned.
Application No. 11/188,169 is a continuation-in-part of application No. 10/528,919, filed on Mar. 23, 2005, now abandoned.
(60) Provisional application No. 60/503,121, filed on Sep. 15, 2003.

(51) Int. Cl. G06Q 40/00

(52) U.S. Cl. 705/39

(57) ABSTRACT

Disclosed herein is a system and method for conducting electronic transactions utilizing a wireless communications device or computer adapted to receive either a URL for accessing an indicia of value stored on a server or an image of the indicia of value. The present system further enables transmission of at least a portion of the indicia of value from one receiving device to another, and simultaneously deleting that transmitted portion from the first user's file on the server. The system also enables a user to transmit an SMS or text message containing information corresponding to an indicia to the server. The server then searches either its own database or that of another server for corresponding indicia. Once located, the server creates a separate file for the user containing that information and sends an SMS, including a URL, back to the device to enable the user to access that indicia.

### CROSS-REFERENCE TO RELATED APPLICATIONS

This application is a continuation of co-pending U.S. patent application Ser. No. 11/188,169, filed Jun. 22, 2005, which is a continuation-in-part of U.S. patent application Ser. No. 10/528,919, filed Mar. 23, 2005, which is the National Stage of International Application No. PCT/US04/30281, filed Sep. 15, 2004, which claims the benefit of U.S. Provisional Application No. 60/503,121, filed Sep. 15, 2003, the entire disclosures of which are incorporated herein by reference.

### FIELD OF THE INVENTION

The present invention relates to a system, device and method for conducting electronic transactions, and more specifically, the present invention relates to electronic transactions utilizing a wireless communications device.

### BACKGROUND OF THE INVENTION

In the above referenced prior-filed application there is disclosed a device, system and method for conducting electronic transactions over the Internet. The system thereof, comprises a wireless communication device having memory storage, a display screen and a microprocessor, where the device is adapted to receive a transaction program and data. The transaction program is stored in the memory storage, the program contains instructions executable by the microprocessor to produce indicia representative of value on the display screen. The indicia representative of value is selected from the group consisting of an identifier of a purchased good, an identifier of a purchased service, a coupon, a discount, a prepaid transaction, an electronic negotiable instrument, a sum from a credit account, a sum from a debit account. A scanner is in communication with a merchant server for reading the indicia from the device. A provider server is accessible by the merchant server for storing and retrieving user account information.

The system of the prior-filed applications, also, includes a scanner that reads the indicia from the screen of the device where, the indicia may be a two dimensional barcode. The indicia may further be interpreted to be representative of a product or service.

The aforementioned prior-filed applications, also, includes a provider server which stores and retrieves user account information and has a commerce program containing instructions executable by the provider server for creating and storing image files and for transmitting a message to the wireless communication device to display the indicia, whereby the image file for the indicia may be stored located on the wireless communications device.

However, the system while being extremely efficacious lacks “full” security in that there is no expiration time for a transaction to be fulfilled; nor is there any facility or means to prevent multiple usage of the indicia of value; nor does it delete the transaction from a server once it is fulfilled or the time has expired. Similarly, the invention of the prior-filed applications fails to address user-to-user transfers via messaging. The present invention addresses these issues.

### SUMMARY OF THE INVENTION

A system for conducting electronic transactions, in accordance herewith, includes a server which comprises:
(1) means for storing an indicia of value,
(2) means for generating an indicia of value,
(3) means for transmitting a URL or an image of indicia of value to a device of a user, the image including the URL therefor,
(4) means for selectively terminating a transaction actuable by a merchant upon scanning the image,
(5) means for selectively fulfilling the transaction actuable by a merchant upon scanning the image,
(6) means for selectively deleting the indicia of value from the server after either a pre-determined time, or upon fulfillment of the transaction.

The present invention also comprises a method for conducting an electronic transaction via the system. The method generally comprises:
(a) generating an indicia of value comprising an identifier of a purchased good or a purchased service, a coupon, a discount, a prepaid transaction, an electronic negotiable instrument, a sum from a credit account, and a sum from a debit account;
(b) providing the indicia of value to a merchant scanner and redeeming the indicia of value; and
(c) transmitting an access to the indicia of value from a server to a receiving device.
(d) retrieving the indicia of value;

The indicia may be a two dimensional bar code, coupon, ticket or the like. The indicia of value may be redeemed by scanning the indicia from the screen of the wireless device.

According to the present invention, the present system further includes means for transmitting an indicia of value from one user to another as well as enabling a user to have the server search a database, via a text message or SMS, for indicia of value and, once found, to transmit a URL back to the user.

The present system further includes a time expiration feature after which the indicia of value is deleted from the server.

Additionally, the present system further comprises means for preventing duplication of an indicia of value including means for deleting the indicia from a user's file, either after the time expiration, transmission of an indicia of value to a second user or upon consummation or fulfillment of a transaction.

The present system may include means for validating or authenticating such as entering a password before the step of retrieving the indicia of value.

Further objects, features and advantages of the present invention will become apparent to those skilled in the art from analysis of the following written description, the accompanying drawings and the appended claims.

### BRIEF DESCRIPTION OF THE DRAWINGS

FIG. 1 is a schematic illustration of the system for conducting electronic transactions according to the principles of the present invention;

FIG. 2 is a is a block diagram revealing a wireless communication device and provider server in further detail;

FIGS. 3a through 3d reveal sample screens displayed by the transaction program for retrieving a movie theatre ticket according to the present invention;

FIG. 4 is an illustration of one method for transmitting access to indicia representative of value according to the principles of the present invention;

FIG. 5a is an illustration of one method for transmitting indicia representative of value, from one wireless device to another, according to the principles of the present invention;

FIG. 5b is a flow chart showing an alternate mode for data flow for transmitting indicia of value from one user to another; and

FIG. 6 is a diagram showing the various modules comprising the overall system;

FIG. 7 is a diagram showing the flow for consummating a transaction, and

FIG. 8 is a diagram showing the components of the management system portion of the present invention, and

FIG. 9 is a flow chart illustrating data flow using text messaging to transmit access to indicia of value.

FIG. 10 is a representation of a link for fulfilling or terminating a transaction.

### DESCRIPTION OF THE PREFERRED EMBODIMENT

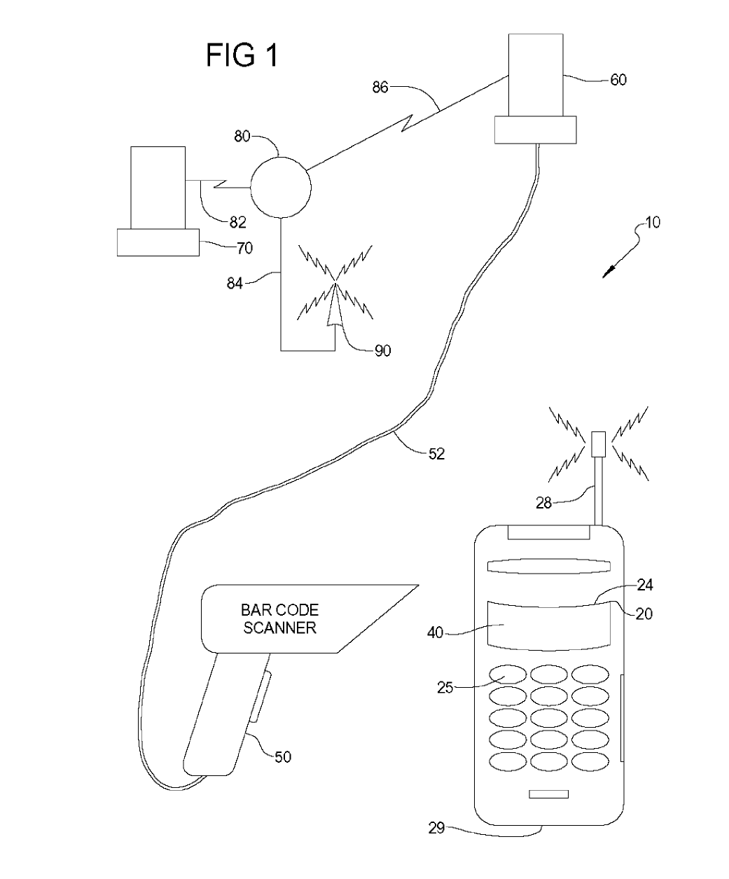

In accordance herewith and with initial reference to FIG. 1, a schematic illustration of a system 10 for conducting electronic transactions according to the principles of the present invention is shown. The system 10 for conducting electronic transactions comprises a receiving device, such as a wireless communications device 20 having a display screen 24 with indicia representing value, a good or service thereon. A scanner 50, is in communication with a merchant server 60 via a cable 52. The scanner 50 may be directly or indirectly coupled to the merchant server 60. For example the scanner 50 may first be in communication with a point-of-sale system which then transmits data to the merchant server 60. Preferably, the scanner is a bar code scanner.

At the outset it should be noted that although the present invention is described herein with reference to wireless communication devices such as mobile phone, PDA, etc. However, it is to be understood the term “receiving device” as used herein includes other devices such as a computer. Furthermore, in lieu of a cable hook-up for the scanner a wireless communication can be deployed.

A server 70 is in communication with a network 80 via a line 82, such as the Internet or a wireless network. The network 80 is in communication with a cellular network 90 via a line 84. The server 70 is accessible by the merchant via a telephone line 86, a PBX or any data transmission system known in the art.

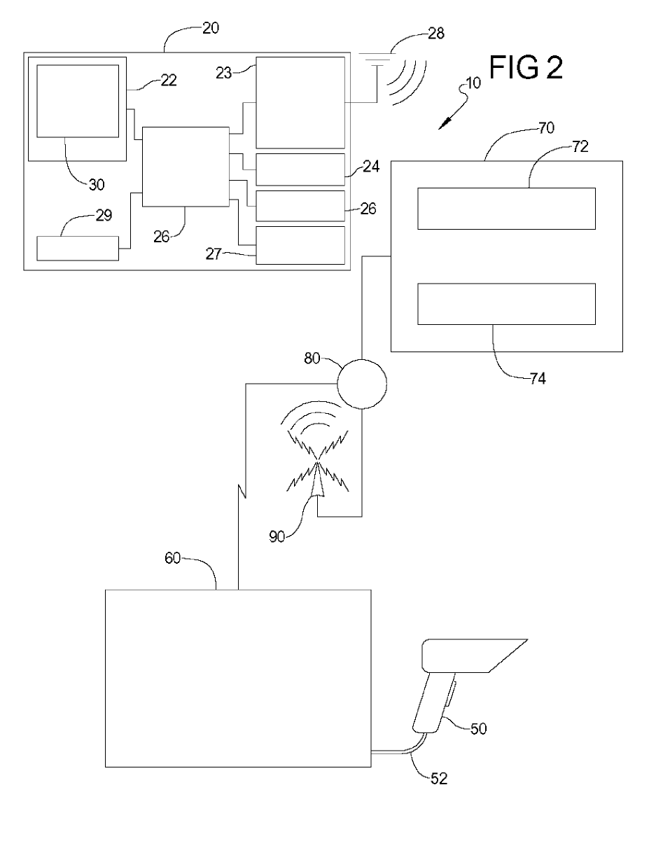

FIG. 2, is a block diagram revealing a wireless communication device and provider server in further detail. The wireless device 20 comprises memory storage 22, an IO port 29, function electronics 23, a display screen 24, a keypad 25 and memory card reader 27 in communication with a microprocessor 26. An antenna 28 is in communication with function electronics 23 and enables device 20 to send and receive data. Alternatively, IO port 29 may enable device 20 to send and receive data, instead of, or in addition to antenna 28. It should be noted however, that any communication technology known the art including infrared, laser, or radio, such as Bluetooth®, may be employed to transmit and receive data.

The scanner 50 may be a commercially available bar code scanner, such as a laser, laser diode, imaging or charge coupled device. Additionally, scanner 50 may scan from any of the above mentioned communication technologies, including, but not limited to direct couple through an IO port, infrared, laser, or radio, such as from the antenna 28.

In the immediate embodiment, device 20 is a cellular telephone. However it should be apparent to those skilled in the art that any wireless device may be substituted for a cellular telephone including, but not limited to, a PDA (personal digital assistant), a handheld computer, or any device that comprises memory storage, a display screen and microprocessor.

The server 70 comprises a commerce program 72 and database 74. The database 74 may include information such as a user name, password, bank account information, credit card information, selected coupons, tickets a prepaid transaction, an electronic negotiable instrument, a sum from a credit account and a sum from a debit account, and the like. The commerce program 72 provides instructions to enable a user to conduct electronic transactions.

The merchant server 60 receives signals from the scanner 50 and communicates with the server 70. The merchant server 60 may also contain its own database for inventory and sales tracking.

In the embodiment of the prior-filed application, the transaction program 30 stored on device 20 creates an indicia 40 representative of value, where value is selected from an identifier of a purchased good, an identifier of a purchased service, a coupon, a discount, a prepaid transaction, an electronic negotiable instrument, a sum from a credit account, and a sum from a debit account. The indicia 40 may also be representative of a product or service. Alternatively, the commerce program 72 on the provider server 70 may create the indicia 40, which is subsequently downloaded by the device 20.

As detailed hereinbelow, according to the present invention, the image of the indicia 40 is not stored on the device 20, but is stored on the server 70.

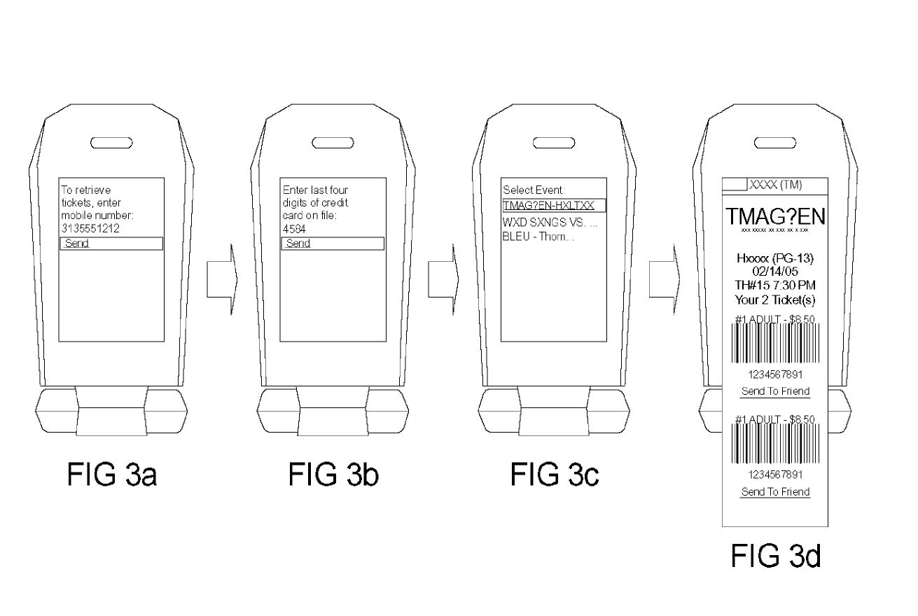

Referring now to FIGS. 3a through 3d, there is shown sample screens displayed by the transaction program 30 for retrieving a movie theater ticket according to the present invention. The retrieval system of the present invention requests a user ID (e.g., a mobile phone number) and verification of the user's identity (e.g., a password or last 4 digits of the credit card number used to facilitate the purchase).

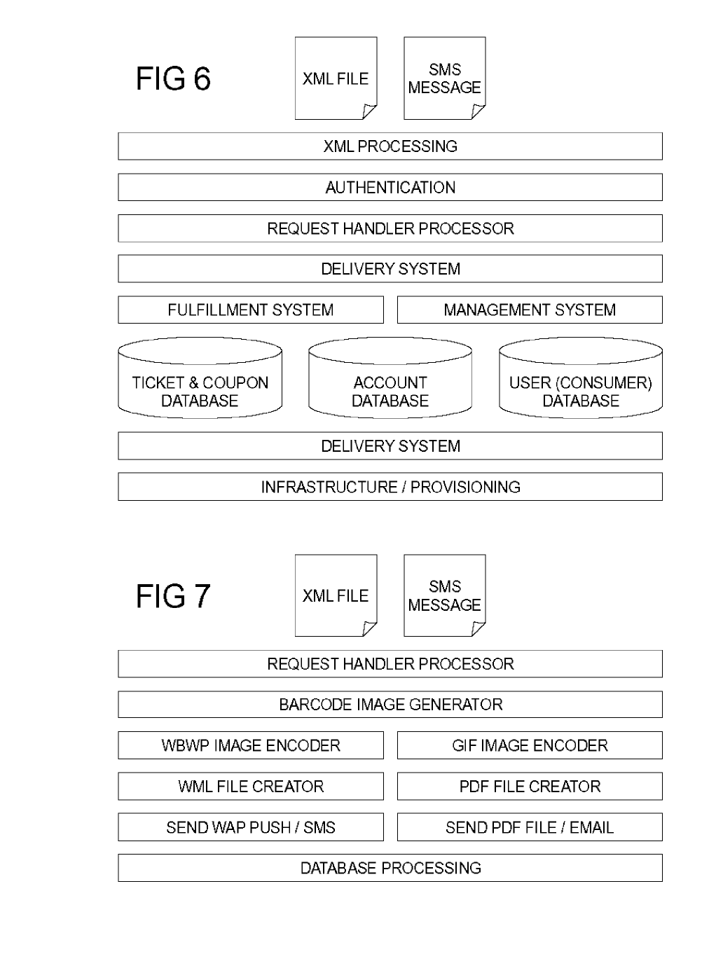

FIG. 3a is an exemplary menu screen for entering user identification, which in the present embodiment is the user's mobile number. The user enters verification of identity, such as a password or the last 4 digits of the user's credit card number, as shown in FIG. 6b. The user then selects an event, which in the present example a movie. The transaction program 30 then displays an indicia of value 40 of the ticket on the screen 24. However, the transaction program 30 only shows indicia 40, which is an identifier of a purchased good, purchased service, a coupon, a discount, a prepaid transaction, an electronic negotiable instrument, a sum from a credit account, and a sum from a debit account. The image file is stored at a remote location, such as at the server 70.

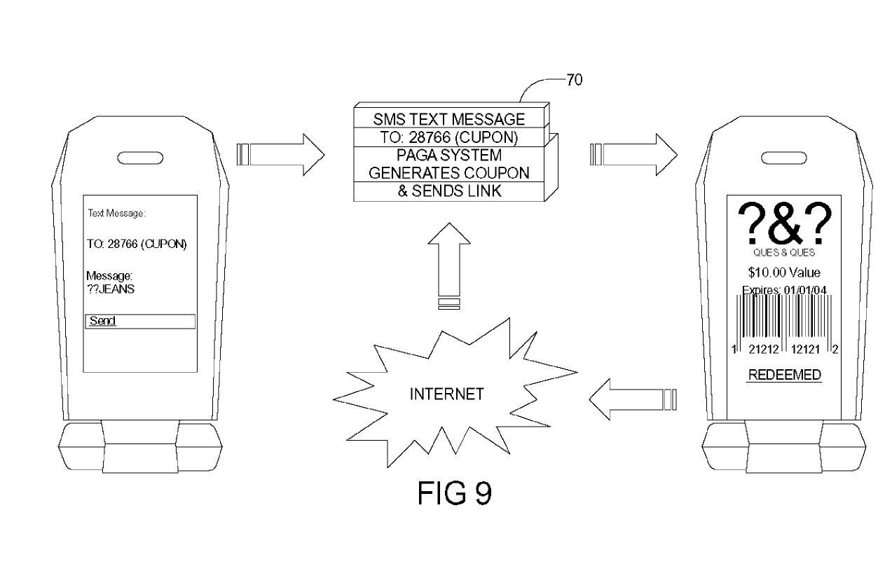

According to the present embodiment and as shown in FIGS. 6 and 9, the commerce program 72 located on the server 70 includes a management system for performing a number of tasks, such as handling requests, account management, billing management, database management and transaction management, for transactions such as tickets, coupons, purchased goods, purchased services, discounts, prepaid transactions, an electronic negotiable instruments, credits, and debits.

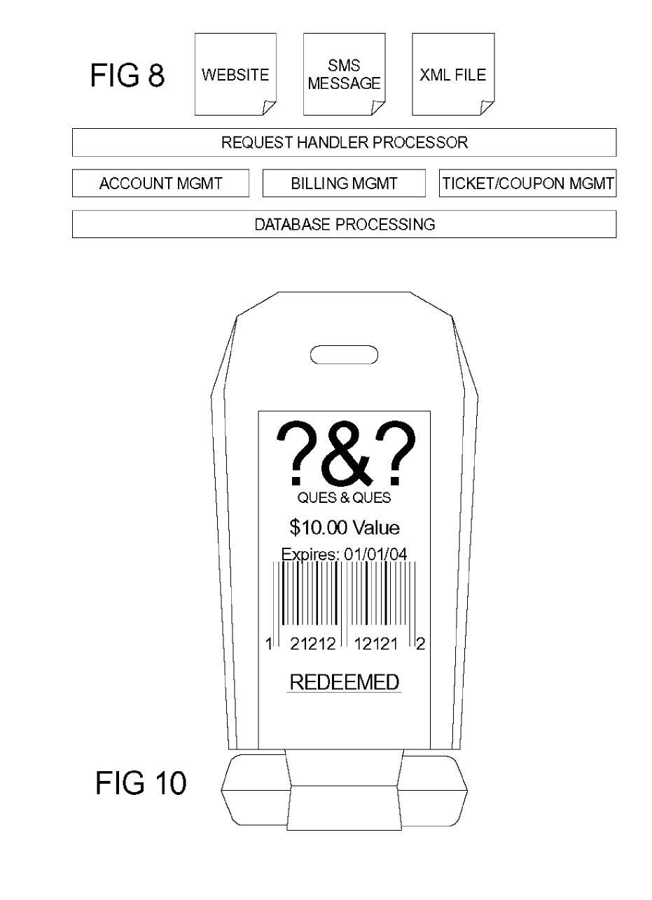

As shown in FIG. 8, the commerce program 72 also includes a processing module, which in the preferred embodiment, processes files in an XML (Extensible Markup Language) designed especially for handling Web documents. In handling web-based documents, an authorization module within the commerce program 72 receives user and/or merchant identification and verification information, and upon a successful match, permits the vendor to conduct their transactions. A request handler module commands a fulfillment module to execute a barcode or other image generator. In the preferred embodiment, the barcode image generator commands a WBMP (Wireless Application Protocol Bitmap Format) image encoder to create a graphics file optimized for the device 20. A WML (Wireless Markup Language) file creator provides a graphics file and supporting information in a format for presentation of a web page(s) on the device 20. The fulfillment module sends a Wap Push or SMS (Short Message Service) message to the user's device 20 as an alert that the image is available. The message includes the URL (Uniform Resource Locator) to locate the file stored at the server 70.

Alternatively, the barcode image generator may command a GIF (Graphic Image File) image encoder to create a graphics file. A PDF file creator provides the graphics file and supporting information in a PDF (Portable Document Format) file. The system may then send a PDF file containing the image via email to the device 20.

It should be noted, and as shown in FIG. 8, the same data flow can be initiated using SMS text messaging in lieu of XML.

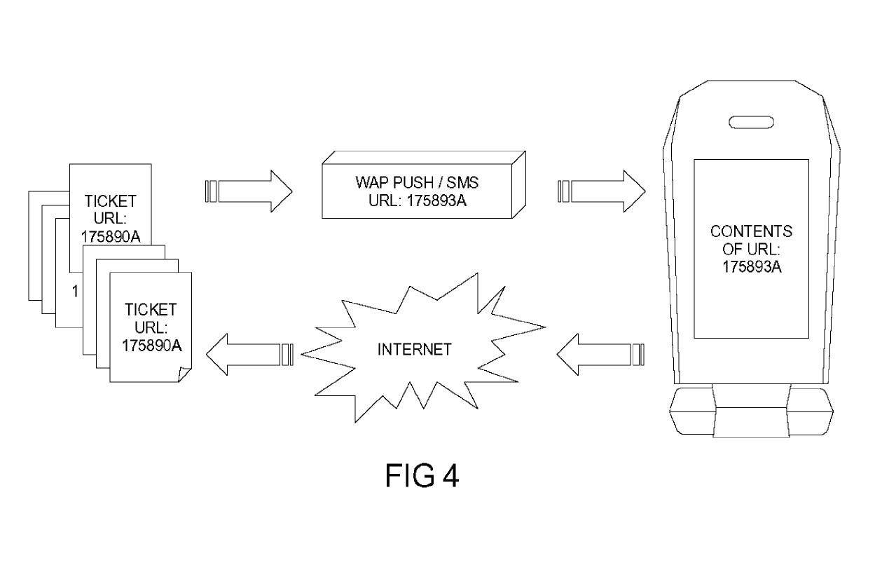

Referring to now FIG. 4, there is illustrated a method for transmitting indicia representative of value according to the principles of the present invention where the indicia of value is on the server 70. Here, WAP push or SMS files, 76 containing the URL for each indicia 40, are located at the server 70. Upon a validated request, the fulfillment module sends a WAP push or SMS message containing the URL to the user's wireless device 20. The user then accesses the message and, then, goes to the URL. Thereafter, the contents, of the file 76, are displayed on the screen 24. Once a merchant scans the indicia 40, a suitable link is activated and sent to the server 70 to complete the transaction, as detailed below.

It should be noted and important hereto is that each WML has a time expiration factor associated therewith such that if the transaction is not finalized by either completing or not completing it within a specified time, then, it is automatically deleted from the server. Thus, the image corresponding to the consummated transaction or non-consummated transaction is deleted from the server 70 upon time expiration. This feature defines one made for preventing multiple usage of the indicia of value.

Optionally, after the time has expired for a given transaction, the server can then provide a new file to be displayed as an indicia 40 on the screen 24. For example, after expiration of a first indicia which is a coupon, a second indicia can then be transmitted to the display, such as a new coupon. It is to be appreciated that this provides a number of potential marketing opportunities. For instance, when a user purchases tickets to an event such as a concert, an indicia may be transmitted to the user's device after the concert has finished. In this case, a suitable indicia may be a coupon for the artist's music, DVD's of the artist's other concerts, merchandising such as clothing, and so forth.

It should be noted that the image handling system of the present invention prevents the indicia of value 40 from being re-used, as the indicia 40 is not stored on the device 20, but is stored in the server in a manner analogous to a website.

Referring now to FIG. 9, there is shown a method for transmitting indicia representative of value using text messaging. As shown in FIG. 9, a user transmits an SMS or text message containing information corresponding to an indicia 40 to the server 70. The server, then, searches either its own database or that of another server, for corresponding indicia. Once located, the server 70 creates a separate file for the user containing that information and sends an SMS, including a URL, back to the device 20 to enable the user to access that indicia.

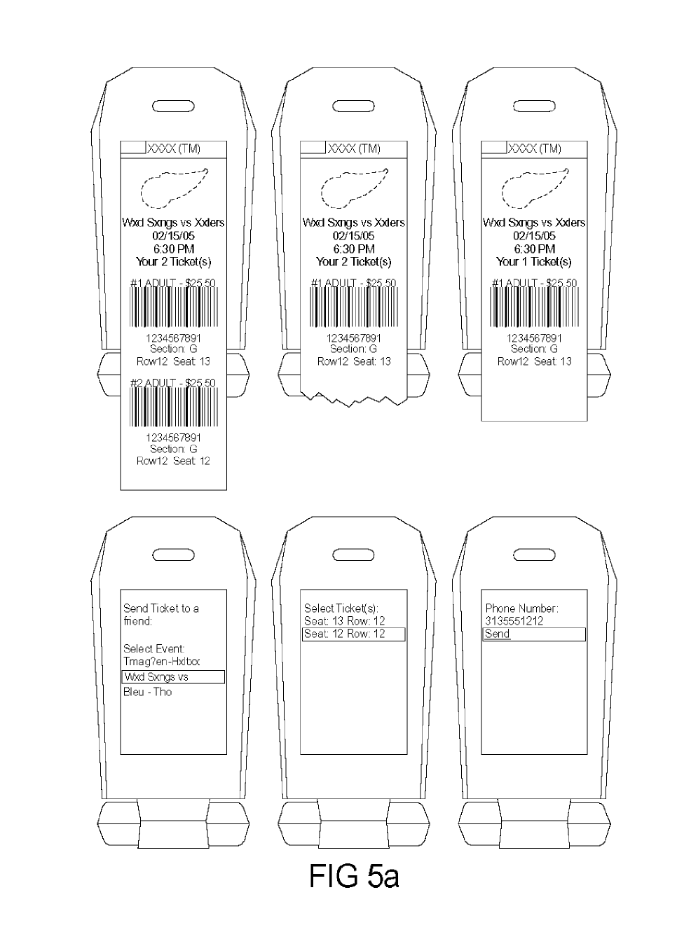

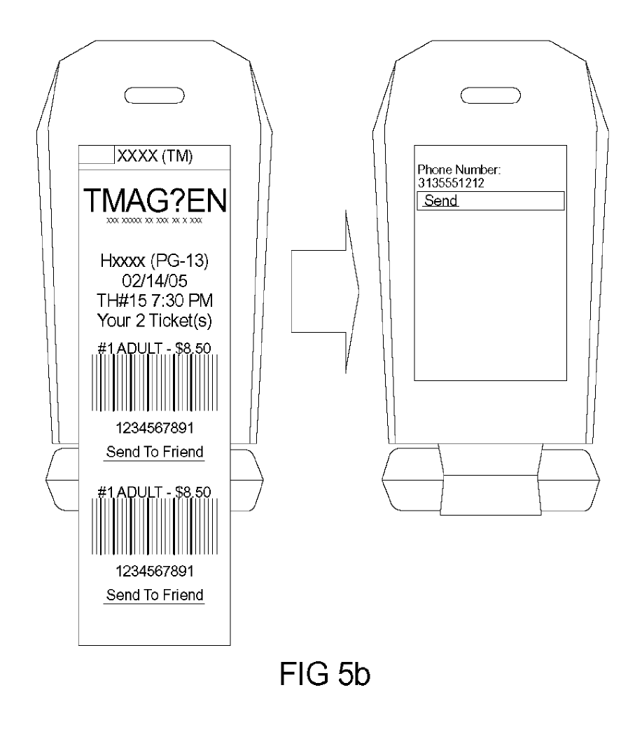

Referring to FIGS. 5a and 5b, and as noted above, the present invention, also, enables a user to transfer a ticket, coupon, or any other item or indicia of value to another user via the system 10. For example, a user having a pair of tickets may send one ticket to another user who will be arriving to an event at a later time. According hereto, the user indicates to the server who is to receive the ticket or other indicia by entering the recipient's mobile phone number, user number, nickname or some other identifier and then presses the “send” button on the device 20. When the program 72 receives the request a new file is created for the recipient and the program 72 sends an SMS containing the URL to the desired recipient. Once forwarded, the sent ticket is automatically deleted from the file of the original user, i.e., the sender, thereby precluding duplication. The recipient receives an alert, such as an SMS including a URL, that a message has arrived and an indicia 40 is displayed on the screen 24 of the mobile device 20. However, once expired, or the transaction is fulfilled the WML is deleted from the server for both indicia, i.e. from both the originator and the recipient's file.

Furthermore, the present invention includes vendor activated means for terminating or removing the indicia of value from the server for that user. According hereto, and as shown in FIG. 10, the screen of the user's communication device displays a suitable representation associated with the indicia of value, and which representation provides a link to terminate or remove the indicia from the server, for that user, for the vendor. More specifically, when the representation here shown as “redeemed” is activated, it automatically links back to the server which, in turn, terminates the indicia of value for that user. Thus, the present invention prevents multiple usage through not only time expiration but upon transaction fulfillment, as well, when the termination link is activated.

From a vendor's standpoint, the vendor is provided with means for accessing the server to prevent an unauthorized vendor from accessing the server. Thus, the vendor is provided with validating or authenticating information which must accompany a vendor's transmission to the server.

From the preceding and as described above the receiving devices receives either a message containing the URL to access the indicia of value or directly receives an image of the indicia of value if the receiving device receives a PDF file. Thus, the receiving device receives an access to the indicia of value either directly or indirectly.

The foregoing discussion discloses and describes the preferred structure and control system for the present invention. However, one skilled in the art will readily recognize from such discussion, and from the accompanying drawings and claims, that various changes, modifications and variations can be made therein without departing from the true spirit and fair scope of the invention as defined in the following claims.

What is claimed is:

1. A method of conducting electronic transactions comprising:
providing a server having a memory;
providing a device for receiving and transmitting data;
storing an image file in the memory of the server;
transmitting data from the server to the device, the data including a URL for locating and accessing the image file;
accessing by the device of the image file stored on the server;
generating an indicia of value using the image file; and
displaying the indicia of value on the device while the image file is stored on the server.

2. The method of claim 1 wherein the indicia of value is selected from the group consisting of an identifier of a purchased good or a purchased service, a coupon, a discount, a prepaid transaction, an electronic negotiable instrument, a sum from a credit account, and a sum from a debit account.

3. The method of claim 1 including:
providing the indicia of value to a merchant scanner and redeeming the indicia of value upon computing a successful scan.

4. The method of claim 3 including:
deleting the image file from the server upon the successful scan, and wherein the indicia of value is consequently removed from display on the device.

5. The method of claim 1 including:
transmitting at least a portion of the indicia of value generated from the image file to a second device upon a request by a user of the device.

6. The method of claim 5 including:
deleting the transmitted portion from the device upon transmission thereof to the second device.

7. The method of claim 2 including:
transmitting at least a portion of the indicia of value generated from the image file to a second device upon a request by a user of the device.

8. The method of claim 7 including:
deleting the transmitted portion from the device upon transmission thereof to the second device.

9. The method of claim 1 further comprising:
transmitting an SMS message to the server from the device;
searching the server for information corresponding or responsive to the message;
creating a file containing the information corresponding to or responsive to the message; and
transmitting a second SMS message back to the device, the second SMS message containing a URL for accessing the information created in the file.

10. A system for conducting an electronic transaction comprising:
a server including means for storing an image file for generating an indicia of value, means for generating an indicia of value on a remote receiving device, means for transmitting a message containing a URL for locating and accessing the indicia of value stored on the server, means for selectively terminating a transaction actuatable by a merchant upon scanning the image, means for selectively fulfilling the transaction actuatable by a merchant upon scanning the image, and means for selectively deleting the image file from the server.

11. The system of claim 10 wherein the message containing the URL to access the image file is an SMS transmittable to the receiving device to alert a user of the image availability.

12. The system of claim 10 wherein the system comprises:
means for transmitting a PDF file to the receiving device, the PDF file comprising an indicia of value.

13. The system of claim 10 which further comprises:
means for authorizing a transaction, the means for authorizing including means for identifying and verifying a user based on a user input of one of a user ID, a password, a portion of a credit card number and a mobile phone number.

14. The system of claim 10 which further comprises:
means for transmitting an SMS from the receiving device to the server to locate an image file in the means for storage, means for searching a database by the server responsive to the SMS, and means for creating a separate file on the server and sending an SMS including a URL back to the device, if the image is located.

15. The system of claim 10 which further comprises:
means for transmitting at least a portion of an indicia of value stored within the means for storing from a first wireless communication device to a second wireless communication device.

16. The system of claim 10 which further comprises:
means for deleting the at least a portion of the indicia value from the first device upon transmission to the second device.
